(19) United States
(12) Patent Application Publication
(10) Pub. No.: US 2024/0343840 A1
(43) Pub. Date: Oct. 17, 2024

(54) PROCESS FOR PRODUCING POLYOLEFIN GRANULAR RESIN WITH INCREASED SETTLED BULK DENSITY

(71) Applicant: W.R. Grace & Co.-Conn., Columbia, MD (US)

(72) Inventors: Ping CAI, Columbia, MD (US); David M. ERDELT, Columbia, MD (US); John Dealon STANLEY, Columbia, MD (US)

(73) Assignee: W.R. Grace & Co.-Conn., Columbia, MD (US)

(21) Appl. No.: 18/682,388

(22) PCT Filed: Aug. 8, 2022
(86) PCT No.: PCT/US2022/039748

§ 371 Date: Feb. 8, 2024

Related U.S. Application Data
(60) Provisional application No. 63/231,007, filed on Aug. 9, 2021.

(51) Int. Cl. C08F 2/34; C08F 2/01; C08F 4/659; C08F 110/06

(52) U.S. Cl. CPC C08F 2/34; C08F 2/01; C08F 4/659; C08F 110/06

(57) ABSTRACT

A process for increasing a settled bulk density of a granular polyolefin polymer includes feeding a catalyst stream into a gas phase polymerization reactor, the catalyst stream comprising catalyst particles, optionally in slurry form by suspending in a mineral oil and/or other hydrocarbon liquid, contained in a carrier fluid; feeding a support gas into the gas phase polymerization reactor together with the catalyst stream entering the reactor, the support gas being fed into the gas phase reactor at a velocity; forming polyolefin particles in the gas phase polymerization reactor through contact with the catalyst particles and a monomer and optionally one or more comonomers; and determining a settled bulk density of the granular polyolefin particles, and, based on the settled bulk density, selectively increasing or decreasing the velocity of the support gas in order to maintain the settled bulk density above a preset limit.

### CROSS REFERENCE TO RELATED APPLICATIONS

This application claims the benefit of priority to U.S. Provisional Patent Application No. 63/231,007 filed Aug. 9, 2021, which is hereby incorporated by reference, in its entirety for any and all purposes.

### BACKGROUND

Polyolefin polymers are used in numerous and diverse applications and fields. Polyolefin polymers, for instance, are thermoplastic polymers that can be easily processed. The polyolefin polymers can also be recycled and reused. Polyolefin polymers are formed from hydrocarbons, such as ethylene, propylene and other alpha-olefins, which are obtained from petrochemicals and other sources and are abundantly available.

Polypropylene, which is one type of polyolefin polymer, generally have a linear structure based on a propylene monomer. Polypropylene can have various different stereospecific configurations. Polypropylene, for example, can be isotactic, syndiotactic, and atactic. Isotactic polypropylene is perhaps the most common form and can be highly crystalline. Polypropylene products that can be produced include homopolymers, modified polypropylene polymers, and polypropylene copolymers which include polypropylene terpolymers. By modifying the polypropylene or copolymerizing the propylene with other monomers, various different polymer-products can be produced having desired properties for particular applications.

One type of method for producing polyolefin polymers is typically referred to as gas phase polymerization. During a typical gas phase polymerization, one or more monomers contact with a catalyst forming a bed of polymer particles maintained in a fluidized state by the fluidizing medium. A typical gas phase polymerization reactor includes a vessel containing a fluidized bed, a distribution plate, and a product discharge system. A catalyst can be fed into the polymerization reactor and contacted with an olefin monomer that forms part of the fluidizing medium.

When producing polyolefin polymers in a gas phase polymerization process, those skilled in the art have attempted to produce a polymer resin comprised of granular polymer particles that have a relatively high settled bulk density (SBD). Increasing the settled bulk density facilitates an easier handling of the polymer resin and can greatly increase the efficiency of the particle discharge system. These benefits are also seen downstream from the reactor when feeding the polymer resin into the feeding hopper of an extruder. Increasing the settled bulk density can debottleneck the solid flow rates though particle discharge system, extruder hopper, rotary feeder, etc., hence to increase the overall production rate of the polymer process.

Determining the process parameters that affect settled bulk density, however, has been problematic. Thus, a need currently exists for a process of producing granular polyolefin polymers with increased settled bulk density. In particular, a need exists for a process for increasing the settled bulk density of granular polyolefin polymers during their production that can be incorporated into all different types of polyolefin production processes that use different catalysts and make different products.

### SUMMARY

In general, the present disclosure is directed to a process and system for producing polyolefin polymer resins. The process of the present disclosure is generally carried out in gas phase reactors. In accordance with the present disclosure, various process parameters are controlled in order to optimize and/or maximize the settled bulk density of the granular polyolefin particles being formed.

In one embodiment, for instance, the present disclosure is directed to a process for increasing the settled bulk density of a polyolefin polymer resin. The process includes feeding a catalyst stream into a gas phase reactor. The catalyst stream comprises catalyst particles contained in a carrier fluid. The catalyst particles can comprise a Ziegler-Natta catalyst or a metallocene catalyst. A support gas is fed into the gas phase reactor through a support tube co-axially with the catalyst stream entering the reactor. The support gas is fed into the gas phase reactor at a velocity.

Polyolefin particles are formed in the gas phase reactor by contacting the catalyst particles with a monomer and optionally one or more comonomers. The settled bulk density of the granular polyolefin particles is determined by ASTM D1895. In accordance with the present disclosure, based upon the determined settled bulk density of the granular polymer produced, the velocity of the support gas is selectively increased or decreased in order to maintain the settled bulk density above a preset level.

In one embodiment, the catalyst stream enters the gas phase reactor through a catalyst inlet having a cross-sectional area and wherein the support gas flows into the gas phase reactor through a support gas inlet that has a cross-sectional area in the range of 0.25 to 4.0 times of that of the catalyst inlet. For example, in one embodiment, the support gas inlet can be concentric with the catalyst inlet and/or catalyst stream. For example, the catalyst stream can be dispensed into the gas phase reactor through a nozzle that is surrounded by the support gas inlet.

The support gas flowing into the gas phase reactor can comprise a monomer gas, an inert gas, or mixtures thereof. In one aspect, the support gas only comprises an inert gas. Alternatively, the support gas may comprise a propylene gas.

The catalyst stream can comprise a suspension containing the catalyst particles combined with the carrier fluid. The suspension can be made from the catalyst particles combined with an oil, such as a mineral oil. The carrier fluid can, in one embodiment, be an inert gas such as nitrogen gas. In an alternative embodiment, the carrier fluid can be liquid propylene.

The velocity of the support gas entering the gas phase reactor can vary widely depending upon various factors, the components contained in the catalyst stream and the support gas stream, and on various other factors. In one embodiment, the velocity of the support gas can range from about 30 m/s to about 200 m/s, such as from about 50 m/s to about 150 m/s. in various embodiments, the process of the present disclosure can be used to maintain the settled bulk density at a preset level of greater than about 250 kg/m³, such as greater than about 350 kg/m³, such as greater than about 380 kg/m³. The maximum settled bulk density that can be obtained is less than about 600 kg/m³.

The process of the present disclosure can be used to increase the settled bulk density of the polyolefin resin when either using a Ziegler-Natta catalyst or a metallocene catalyst, or even a mixture of Ziegler-Natta and metallocene catalysts. For example, in one embodiment, the catalyst system comprises a Ziegler-Natta solid catalyst, an external electron donor comprising a selectivity control agent (SCA), and optionally an activity limiting agent (ALA). The solid catalyst can comprise a magnesium moiety, a titanium moiety, and an internal electron donor. In one aspect, the internal electron donor is a substituted phenylene diester or a phthalate compound. In one aspect, the solid catalyst component can further comprise an organosilicon compound and an epoxy compound.

Alternatively, the catalyst system can comprise a metallocene catalyst. The metallocene catalyst may comprise:

(C₅Rₓ)_{y}R′_{z}(C₅Rₘ)MQ_{n-y-1}

In the above formula, M is a metal of Groups III to VIII of the Periodic Table of the Elements; (C₅Rₓ) and (C₅Rₘ) are the same or different cyclopentadienyl or substituted cyclopentadienyl groups bonded to M; R is the same or different and is hydrogen or a hydrocarbyl radical such as alkyl, alkenyl, aryl, alkylaryl, or arylalkyl radical containing from 1 to 20 carbon atoms or two carbon atoms are joined together to form a C₄-C₆ ring; R′ is a C₁-C₄ substituted or unsubstituted alkylene radical, a dialkyl or diaryl germanium or silicon, or an alkyl or aryl phosphine or amine radical bridging two (C₅Rₓ) and (C₅Rₘ) rings; Q is a hydrocarbyl radical such as aryl, alkyl, alkenyl, alkylaryl, or aryl alkyl radical having from 1-20 carbon atoms, hydrocarboxy radical having from 1-20 carbon atoms or halogen and can be the same or different from each other; z is 0 or 1; y is 0, 1 or 2; z is 0 when y is 0; n is 0, 1, 2, 3, or 4 depending upon the valence state of M; and n−y≥1.

The process and system of the present disclosure can include a controller for carrying out the process. The controller, for instance, can be any suitable programmable device, such as one or more microprocessors. In one embodiment, the determined settled bulk density of the polyolefin resin can be communicated to the controller and the controller can be configured to control the velocity of the support gas fed into the gas phase reactor based upon the determined settled bulk density in order to maintain the settled bulk density above the preset limit. In one embodiment, the controller can operate with an open feed loop. Alternatively, the controller can operate with a closed feed loop.

Other features and aspects of the present disclosure are discussed in greater detail below.

### BRIEF DESCRIPTION OF THE DRAWINGS

A full and enabling disclosure is set forth more particularly in the remainder of the specification, including reference to the accompanying figures, in which:

FIG. 1 is a diagrammatical view of one embodiment of a gas phase polymerization process in accordance with the present disclosure; and

FIG. 2 is a cross-sectional view of a catalyst injection device that may be used in accordance with the present disclosure.

Repeated use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a process and system for optimizing and/or maximizing the settled bulk density of a polyolefin resin during production of the resin. The polyolefin resin is formed by contacting a catalyst with a monomer and optionally one or more comonomers to form polyolefin particles. The granular polyolefin formed can be a polypropylene homopolymer, a polypropylene copolymer, a polyethylene homopolymer, a polyethylene copolymer, or the like. Increasing the settled bulk density of the formed polymer particles in accordance with the present disclosure facilitates handling of the polymer resin resulting in greater throughput and process efficiencies.

The present disclosure is generally directed to manipulating various variables in gas phase polymerization processes used to produce polyolefin polymers. Through the process of the present disclosure, the settled bulk density can be increased and maximized which increases the efficiencies of the polymer discharge system of the reactor and other units downstream the reactor, such as product purge bin, and rotary valve(s). Higher settled bulk density also facilitates conveying the product to an extruder and facilitates feeding the polymer resin into an extruder for producing polymer pellets or articles.

During gas phase polymerization processes, catalyst particles contained in a carrier fluid are injected into a fluidized-bed reactor. Typically, the catalyst particles are mixed with an oil, such as a mineral oil, to form a slurry and then combined with the carrier fluid. The carrier fluid can be, for example, liquid propylene or an inert gas, such as nitrogen gas. The catalyst inlet within the reactor can be surrounded with a coaxial supporting tube that feeds a support gas into the gas phase reactor with the catalyst stream. The support gas is designed to help disperse the catalyst particles and allow the catalyst particles to better penetrate into the reactor to prevent local enrichment of fresh catalyst, which could cause localized high temperature areas or spots within the reactor.

In accordance with the present disclosure, the velocity of the support gas where the support gas contacts the catalyst stream is controlled in order to maximize or increase settled bulk density. Although it was discovered that the velocity of the support gas can significantly influence settled bulk density, selection of a velocity or velocity range for any particular polymerization process can depend upon different factors. For example, the ability to increase settled bulk density by adjusting the velocity of the support gas is catalyst dependent. In other words, the velocity of the support gas can be adjusted based upon the particular catalyst used during polymerization. Understanding the relationship between support gas velocity and the catalyst, however, also makes the process robust in that the process of the present disclosure can be used to increase settled bulk density when producing any type of polyolefin polymer using any particular type of catalyst, whether the catalyst is a Ziegler-Natta catalyst or a metallocene catalyst.

It is believed that the velocity of the support gas is related to the attrition of the catalyst particles, which then in turn influences polyolefin particle formation and therefore influences particle morphology including settled bulk density. Polymerization of the monomer(s) occurs at active sites on the catalyst particles. A single catalyst particle can include numerous amounts of active sites. The polyolefin polymer forms at the active sites on the catalyst particles to form microparticles. These microparticles then agglomerate to form granular polyolefin particles. This is so-called “multigrain model of polymer growth” (see Hutchinson et al., Journal of Applied Polymer Science, Vol. 44, pp 1389-1414 (1992)). Ideally, the microparticles forming on the catalyst support continue to grow until no intra-particle voids remain between adjacent microparticles resulting in voidless granular particles, although the complete voidless granular particles have never been achieved by any commercial gas-phase polymerization process. Reducing the intra-particle voids has been found to increase bulk density and improve the handling properties of the resulting resin.

In one embodiment of the present disclosure, the velocity of the support gas in the gas phase process is used to control the attrition of the catalyst for reducing the catalyst particle size. Reducing the catalyst particle size, for instance, can lead to polymer particle formation with less voids and therefore a higher settled bulk density. For example, when the catalyst particle size is reduced, more heat transfer surfaces of the particles are generated which help to reduce the local temperature around each active site on the catalyst. In addition, the heat generated by each catalyst particle is also reduced. It is believed that when the polymer microparticles growing on the active sites are sufficiently cooled or remain at a relatively lower temperatures, the microparticles keep growing until reaching neighboring microparticles, which can dramatically reduce intra-particle voids. On the other hand, if an active site is hot enough, it could kinetically reduce and terminate the catalytic activity of the active site so the microparticle grown on the active site would stop growing, hence may leave voids between the neighboring microparticles. Therefore, if the catalyst particle size is relatively large, there is less surface area available for heat transfer, and the heat generated in each particle would be more, which may cause relatively higher temperature around the active sites causing polymer growth to halt. If the polymer microparticles at each active site discontinue expanding, the resulting polymer particles may have greater void space. Consequently, for some catalyst particles, increasing the velocity of the support gas can reduce the catalyst particle size through attrition, hence increase the settled bulk density.

Other catalyst particles, however, are more attrition-prone to form particles with irregular shapes. Irregular shaped catalyst particles include active sites at non-uniform positions. The polymer microparticles that form at the active sites thus do not uniformly grow together as would happen if the catalyst particle were more spherical. That may cause a worsen particle-to-bed heat transfer and promote a relatively higher temperature at some active sites. Consequently, irregular shaped catalyst particles lead to greater voids and can in turn reduce settled bulk density. In addition, the final granular polymer product, if with irregular particle shape, would also reduce the settled bulk density because the “packing” of irregular-shaped particles would leave more inter-particle voids among particles.

Consequently, as described above, the velocity of the support gas can be adjusted and controlled based upon the type of catalyst particle contained within the process. In certain embodiments, relatively higher gas velocities may be desired. However, in other embodiments, relatively lower gas velocities may be preferred.

As described above, the system and process of the present disclosure are particularly applicable to gas phase polymerization processes. As used herein, typically, “gas phase polymerization” is the passage of an ascending fluidizing medium, the fluidizing medium containing one or more monomers, in the presence of a catalyst through a fluidized bed of polymer particles maintained in a fluidized state by the fluidizing medium. “Fluidization,” “fluidized,” or “fluidizing” is a gas-solid contacting process in which a bed of finely divided polymer particles is lifted and agitated by a rising stream of fluid. Fluidization occurs in a bed of particulates when an upward flow of fluid through the interstices of the bed of particles attains a pressure differential and frictional resistance increment exceeding particulate weight, i.e., the particles are suspended by the fluid instead of motionless. Thus, a “fluidized bed” is a plurality of polymer particles suspended in a fluidized state by a stream of a fluidizing medium. A “fluidizing medium” typically contains one or more olefin monomer(s), hydrogen (as chain-termination agent of the polymerization reaction), inert gas (such as N2 and saturated hydrocarbons) optionally a liquid (such as a condensed hydrocarbon, in the discrete form of droplets) which ascends through the gas-phase reactor.

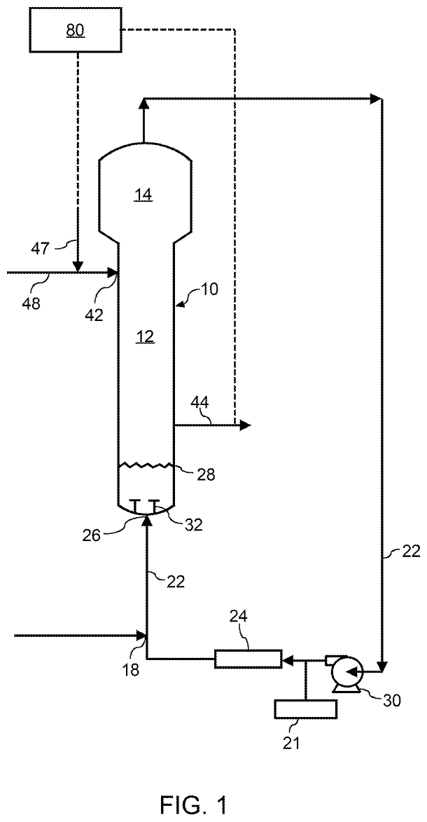

The reactor itself may be any gas phase reactor known in the art. In a preferred embodiment the reactor is a fluidized bed reactor such as depicted in FIG. 1. The reactor can also be arranged horizontally or vertically or in other arrangements, as is generally known in the art.

It should be understood that various changes and modifications to the presently preferred embodiments described herein will be apparent to those skilled in the art. Such changes and modifications can be made without departing from the spirit and scope of the present disclosure and without diminishing its intended advantages. It is therefore intended that such changes and modifications be covered by the appended claims.

A typical gas-phase polymerization reactor includes a vessel (i.e., the reactor), the fluidized bed, a distributor plate, inlet and outlet piping, a compressor, a cycle gas cooler or heat exchanger, and a product discharge system. The vessel includes a reaction zone and a velocity reduction zone, each of which is located above the distribution plate. The fluidized bed is located in the reaction zone. In an embodiment, the fluidizing medium includes propylene gas and other gases such as hydrogen or nitrogen, and optional other olefin(s) with carbon number of 2 or 4 to 10.

Catalyst is typically fed into a lower section of the reactor. Reaction occurs upon contact between the catalyst and the fluidizing medium yielding growing polymer particles. The fluidizing medium passes upward through the fluidized bed, providing a medium for heat transfer and fluidization. The reactor includes an expanded section located above the reaction section. In the expanded section, the velocity of the fluidizing medium is reduced. Particles having terminal velocities higher than the velocity of the fluidizing medium disentrain from the fluidizing medium stream, and return to the dense fluidized bed by gravity. Some fine particles, with their terminal velocities smaller than the gas velocity, could be carried by the fluidizing medium out of the reactor. Thus, the expended section, with the function of reducing fluidizing medium velocity, can promote the returning of polymer particle to the dense fluidized bed, and minimize the amount of fine particles leaving the reactor. After leaving the reactor, the fluidizing medium passes through a compressor and one or more heat exchangers to remove the heat of polymerization before it is re-introduced into the reaction section of the reactor through the distributor plate. The fluidizing medium may or may not contain an amount of liquid after cooling and condensing.

One or more olefin monomers can be introduced in the gas-phase reactor to react with the catalyst and to form a polymer, in the form of granular polymer particles. Nonlimiting examples of suitable olefin monomers include ethylene, propylene, C₄₋₂₀ α-olefins, such as C₄₋₁₂ α-olefins such as 1-butene, 1-pentene, 1-hexene, 4-methyl-1-pentene, 1-heptene, 1-octene, 1-decene, 1-dodecene and the like; C₄₋₂₀ diolefins, such as 1,3-butadiene, 1,3-pentadiene, norbornadiene, 5-ethylidene-2-norbornene (ENB) and dicyclopentadiene; C₈₋₂₀ vinyl aromatic compounds including styrene, o-, m-, and p-methylstyrene, divinylbenzene, vinylbiphenyl, vinylnaphthalene; and halogen-substituted C₈₋₄₀ vinyl aromatic compounds such as chlorostyrene and fluorostyrene.

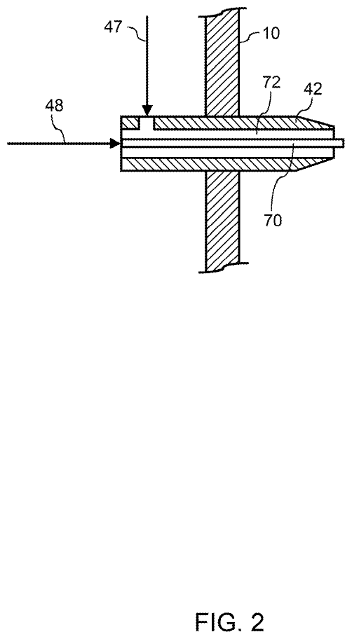

Referring to FIGS. 1 and 2, for exemplary purposes only, one embodiment of a gas phase polymerization process is illustrated. As shown in FIG. 1, the system includes a gas phase reactor 10 that includes a reaction zone 12 and a velocity reduction zone 14. In one exemplary embodiment, the height to diameter ratio of the reaction zone can vary in the range of from about 2:1 to about 7:1.

The reaction zone 12 includes a bed of growing and grown polymer particles, polymerizable monomer(s) and other gaseous components (including hydrogen and inert gases) in the form of fluidizing medium that flows through the reaction zone. The superficial gas velocity (SGV) of the fluidizing medium (typically in gaseous status in most parts of the reactor) is sufficient to produce a fluidized bed. For instance, the superficial gas velocity within the reaction zone 12 can be from about 0.1 ft/s to about 6 ft/s. The superficial gas velocity, for example, can be greater than about 0.2 ft/s, such as greater than about 0.4 ft/s, such as greater than about 0.7 ft/s, and is generally less than about 3.0 ft/s. The superficial gas velocity is larger than the minimum fluidization velocity of the particle bed. For example, the superficial gas velocity, can be greater than 1.5 times, such as greater than 2.5 times, such as greater than 4 times of the minimum fluidization velocity.

Make-up fluidizing medium (such as fresh polyolefin monomer(s) to make up those consumed during the polymerization) is generally fed to the process at point 18, or other locations in the cycle loop such as upstream of the compressor 30, and combined with a recycle line 22. The composition of the recycle stream is typically measured by a gas analyzer 21. The superficial gas velocity in the reactor 10 can be adjusted by adjusting the flow rate of the fluidizing medium passing the compressor 30. The gas analyzer 21, as shown in FIG. 1, can be positioned to test the recycled gas at a point between a compressor 30 and a heat exchanger 24.

The fluidizing medium contained in the recycle stream 22 is fed to the reactor 10 towards the bottom at a point 26 below the bed. The reactor 10 can include a gas distribution plate 28 to aid in fluidizing the bed uniformly and to support the solid particles contained in the fluidized bed prior to start-up or when the system is shut down. The fluidizing medium passing upwardly through and out of the bed removes the heat of reaction generated by the exothermic polymerization reaction.

As shown in FIG. 1, the fluidizing medium flows through the reactor 10 and into the velocity reduction zone 14. Within the velocity reduction zone 14, most particles drop back to the dense fluidized bed in the reaction zone 12, while small amount of fine particles are carried out of the reactor by the fluidizing medium into the cycle loop.

The recycled fluidizing medium is compressed in compressor 30 and passed through a heat exchanger 24. The heat exchanger 24 is for removing the polymerization-reaction heat absorbed by the fluidizing medium when passing the reactor, before the fluidizing medium is returned to the reactor 10. In one aspect, the reactor 10 can include a fluid flow deflector 32 installed at the inlet to the reactor to help better distribute the fluidizing medium in the space below the distributor plate 28, and prevent contained polymer particles from settling out and agglomerating into a solid mass and to maintain and entrain or to re-entrain any particles or liquid which may settle out or become disentrained. Then the distributor plate 28 enables the fluidizing medium to enter the fluidized bed in the reaction zone 12 with a uniform velocity and uniform amount of carried fines particles and optionally uniform amount of condensed liquid, in the entire cross-sectional area of the reactor.

Granular polyolefin polymer resin produced by the reaction is discharged from the reactor 10 through the line 44. As described above, by maintaining the settled bulk density of the polymer particles above a preset limit, handling and conveying of the polymer particles is facilitated. For example, a relatively high settled bulk density would allow a relatively high “discharge efficiency,” which mean less amount of fluid would be discharged together with the polymer particles. Those fluid being discharged would need to be further processed (e.g., returning to the reactor) for economic and safety reasons. Also a smaller amount of fluid being discharged could reduce the interruption of the reactor operation. So, a relatively small amount of the fluid discharged is desired.

The polymerization catalyst enters the reactor 10 through a nozzle 42 through line 48. The nozzle 42 is shown in more detail in FIG. 2.

The catalyst stream 48 includes the catalyst particles, optionally a suspending liquid, such as mineral oil or a liquid alkane, and a carrier fluid. The catalyst particles (for example, in the form of slurry by suspending in mineral oil) and the carrier fluid are injected into the reactor 10 through the nozzle 42. On a volume basis, the catalyst stream 48 primarily contains the carrier fluid. For example, the carrier fluid accounts for greater than 50%, such as greater than 60%, such as greater than 70% of the volume of the catalyst stream 48.

The carrier fluid in the catalyst stream 48 can comprise a monomer, a comonomer, an inert hydrocarbon, an inert gas, or mixtures thereof. In one embodiment, for instance, the carrier fluid is a liquid monomer, such as liquid propylene. When liquid propylene is used as the carrier fluid, the flow rate of the catalyst stream 48 is generally greater than about 15 kg/h, such as greater than about 25 kg/h, such as greater than about 35 kg/h. When liquid propylene is used as the carrier fluid, the flow rate of the catalyst stream 48 is generally less than about 250 kg/h, such as less than about 210 kg/h.

Alternatively, the carrier fluid can be an inert gas, such as nitrogen gas. When nitrogen gas is the carrier fluid, the flow rate of the catalyst stream 48 can generally be greater than about 3 kg/h, such as greater than about 5 kg/h, such as greater than about 7 kg/h, and generally less than about 55 kg/h, such as less than about 45 kg/h, such as less than about 35 kg/h.

In addition to the catalyst stream 48, as shown in FIG. 1, the system further includes a support gas stream 47. The support gas stream 47 is separate from the catalyst stream 48 until released into the reactor 10. In one aspect, for instance, the support gas stream 47 is fed into the gas phase reactor 10 through the nozzle 42 in a manner such that the support gas is released at the tip of tube very close to the tip of the catalyst injection tube. Typically, the support gas flows in the support tube which is coaxially arranged with the catalyst injection tube.

The support gas stream can generally comprise a monomer, a comonomer, an inert hydrocarbon, an inert gas, or mixtures thereof. In one embodiment, for instance, the support gas can comprise a monomer gas, such as an olefin gas. In one particular embodiment, for instance, the support gas can be vaporized propylene. In general, the flow rate of the support gas is greater than about 40 kg/h, such as greater than about 50 kg/h, such as greater than about 60 kg/h. The flow rate of the support gas is generally less than about 600 kg/h, such as less than about 550 kg/h, such as less than about 500 kg/h. In one aspect, the flow rate is greater than about 410 kg/h, such as greater than about 430 kg/h and less than about 700 kg/h. The above flow rates are particularly relevant when using vaporized propylene as the support gas.

Referring to FIG. 2, the nozzle 42 for injecting the catalyst stream 48 and the support gas stream 47 into the polymerization reactor 10 is shown in more detail. As illustrated, the catalyst stream 48, in one embodiment, enters a central flow path 70. The flow path 70 defines a cross-sectional area. The support gas stream 47 enters the nozzle 42 into an annular path 72. The flow path 72 has, in one embodiment, a cross-sectional area about 0.25 to 4.0 times of that of the of the central flow path 70 (based on internal diameters). In one embodiment, for instance, the flow path 72 is concentric with the central flow path 70.

As the catalyst stream 48 and the support gas stream 47 are injected into the reactor 10, as described above, the support gas stream 47 was found to have an effect on catalyst attrition that is catalyst dependent. More particularly, in accordance with the present disclosure, the velocity of the flow gas stream 47 at the exit of the nozzle 42 can be controlled and adjusted for controlling and adjusting polymer resin formation which can ultimately have an impact on the settled bulk density of the formed particles.

The velocity of the support gas at the exit of the nozzle 42 can vary widely depending upon the particular application and the desired result. For example, the velocity of the support gas stream 47 can be adjusted and controlled based upon the catalyst particles present in the feeding system and the reactor and the desired settled bulk density that is to be obtained.

In general, the velocity of the support gas flow rate 47 can be anywhere from about 5.4 m/s to about 81 m/s, including all increments of 1 m/s therebetween. For example, the support gas velocity can be greater than about 5.4 m/s, such as greater than about 6.8 m/s, such as greater than about 8.1 m/s. For many embodiments, the velocity of the support gas stream 47 is less than about 81 m/s, such as less than about 75 m/s, such as less than about 68 m/s. The temperature of the support gas stream 47 can also be a factor in determining the velocity. The support gas stream 47, for instance, can be at a temperature of anywhere from about 23° C. to about 150° C. When the support gas stream 47 contains vaporized propylene, for instance, the temperature of the support gas stream 47 can be from about 100° C. to about 150° C., such as from about 120° C. to about 130° C.

Referring back to FIG. 1, the system of the present disclosure can also include a controller 80. The controller 80 can be any suitable programmable device or logic device. The controller 80, for instance, can be one or more microprocessors or the like. As shown in FIG. 1, the controller 80 is in communication with the polymer discharge line 44 and the supply gas stream 47. For example, the controller 80 can receive a settled bulk density measurement of polymer resin formed in the reactor 10 and, based upon the settled bulk density, adjust the velocity of the support gas stream 47 for maintaining the settled bulk density of the polymer resin above a preset limit. For example, in certain embodiments, depending upon the polymer being produced and the catalyst used, the preset limit of the settled bulk density can be greater than about 250 kg/m³, such as greater than about 300 kg/m³, such as greater than about 350 kg/m³, such as greater than about 400 kg/m³. The settled bulk density generally is at a maximum at less than about 600 kg/m³ for most of the polyolefin powders.

The controller 80, as shown in FIG. 1, can operate in an open loop manner or in a closed loop manner. In an open loop manner, a user may provide inputs for adjusting the velocity of the support gas stream 47. In a closed loop system, the controller 80 can automatically adjust the velocity of the support gas stream 47 based upon settled bulk density measurements. The settled bulk density of granular polymer powder is commonly measured according to ASTM D1895.

As described above, the velocity of the support gas stream exiting the nozzle 42 is catalyst dependent in optimizing or maximizing the settled bulk density. Of particular advantage, the process and system of the present disclosure can be used to optimize settled bulk density of the polymer resin being produced whether using a Ziegler-Natta catalyst or a metallocene catalyst, or the mixture of them.

In an embodiment, the catalyst composition is a Ziegler-Natta catalyst composition. As used herein, a “Ziegler-Natta catalyst composition” is a combination of (1) a transition metal compound of an element for Periodic table groups IV to VIII (procatalyst) and (2) an organometallic compound of a metal from Periodic Table groups I to III (cocatalyst). These components of the catalyst can be added together or separately to the reactor. Nonlimiting examples of the gas phase polymerization reactors have the procatalyst and cocatalyst fed separately into the reactor, i.e., only the procatalyst passing through Nozzle 42 in FIG. 2. Nonlimiting examples of suitable Ziegler-Natta procatalysts include oxyhalides of titanium, vanadium, chromium, molybdenum, and zirconium. Nonlimiting examples of Ziegler-Natta cocatalysts include hydrides, alkyls, or aryls of aluminum, lithium, zinc, tin, cadmium, beryllium, and magnesium.

In general, Ziegler-Natta catalysts have different attrition properties than metallocene catalysts. In one aspect, a Ziegler-Natta catalyst may be more attrition prone. Thus, for some Ziegler-Natta catalysts, typically a relatively lower support gas stream velocity may be used to increase settled bulk density, in certain applications.

All different types of Ziegler-Natta catalysts may be used in the process of the present disclosure. A Ziegler-Natta catalyst includes a solid catalyst component. The solid catalyst component can include (i) magnesium, (ii) a transition metal compound of an element from Periodic Table groups IV to VIII, (iii) a halide, an oxyhalide, and/or an alkoxide of (i) and/or (ii), and (iv) combinations of (i), (ii), and (iii). Nonlimiting examples of suitable catalyst components include halides, oxyhalides, and alkoxides of magnesium, manganese, titanium, vanadium, chromium, molybdenum, zirconium, hafnium, and combinations thereof.

In one embodiment, the preparation of the catalyst component involves halogenation of mixed magnesium and titanium alkoxides.

In various embodiments, the catalyst component is a magnesium moiety compound (MagMo), a mixed magnesium titanium compound (MagTi), or a benzoate-containing magnesium chloride compound (BenMag). In one embodiment, the catalyst precursor is a magnesium moiety (“MagMo”) precursor. The MagMo precursor includes a magnesium moiety. Nonlimiting examples of suitable magnesium moieties include anhydrous magnesium chloride and/or its alcohol adduct, magnesium alkoxide or aryloxide, mixed magnesium alkoxy halide, and/or carboxylated magnesium dialkoxide or aryloxide. In one embodiment, the MagMo precursor is a magnesium di(C₁₋₄)alkoxide. In a further embodiment, the MagMo precursor is diethoxymagnesium.

In another embodiment, the catalyst component is a mixed magnesium/titanium compound (“MagTi”). The “MagTi precursor” has the formula Mg_{d}Ti(OR^{e})fX_{g} wherein R^{e} is an aliphatic or aromatic hydrocarbon radical having 1 to 14 carbon atoms or COR′ wherein R′ is an aliphatic or aromatic hydrocarbon radical having 1 to 14 carbon atoms; each OR^{e} group is the same or different; X is independently chlorine, bromine or iodine, preferably chlorine; d is 0.5 to 56, or 2 to 4; f is 2 to 116 or 5 to 15; and g is 0.5 to 116, or 1 to 3. The precursors are prepared by controlled precipitation through removal of an alcohol from the reaction mixture used in their preparation. In an embodiment, a reaction medium comprises a mixture of an aromatic liquid, especially a chlorinated aromatic compound, most especially chlorobenzene, with an alkanol, especially ethanol. Suitable halogenating agents include titanium tetrabromide, titanium tetrachloride or titanium trichloride, especially titanium tetrachloride. Removal of the alkanol from the solution used in the halogenation, results in precipitation of the solid precursor, having especially desirable morphology and surface area. Moreover, the resulting precursors are in general particularly uniform in particle size.

In another embodiment, the catalyst precursor is a benzoate-containing magnesium chloride material (“BenMag”). As used herein, a “benzoate-containing magnesium chloride” (“BenMag”) can be a catalyst (i.e., a halogenated catalyst component) containing a benzoate internal electron donor. The BenMag material may also include a titanium moiety, such as a titanium halide. The benzoate internal donor is labile and can be replaced by other electron donors during catalyst and/or catalyst synthesis. Nonlimiting examples of suitable benzoate groups include ethyl benzoate, methyl benzoate, ethyl p-methoxybenzoate, methyl p-ethoxybenzoate, ethyl p-ethoxybenzoate, ethyl p-chlorobenzoate. In one embodiment, the benzoate group is ethyl benzoate. In an embodiment, the BenMag catalyst component may be a product of halogenation of any catalyst component (i.e., a MagMo precursor or a MagTi precursor) in the presence of a benzoate compound.

In another embodiment, the solid catalyst component can be formed from a magnesium moiety, a titanium moiety, an epoxy compound, an organosilicon compound, and an internal electron donor. In one embodiment, an organic phosphorus compound can also be incorporated into the solid catalyst component. For example, in one embodiment, a halide-containing magnesium compound can be dissolved in a mixture that includes an epoxy compound, an organic phosphorus compound, and a hydrocarbon solvent. The resulting solution can be treated with a titanium compound in the presence of an organosilicon compound and optionally with an internal electron donor to form a solid precipitate. The solid precipitate can then be treated with further amounts of a titanium compound. The titanium compound used to form the catalyst can have the following chemical formula:

Ti(OR)_{g}X_{4-g}

where each R is independently a C₁-C₄ alkyl; X is Br, Cl, or I; and g is 0, 1, 2, 3, or 4.

In some embodiments, the organosilicon is a monomeric or polymeric compound. The organosilicon compound may contain —Si—O—Si— groups inside of one molecule or between others. Other illustrative examples of an organosilicon compound include polydialkylsiloxane and/or tetraalkoxysilane. Such compounds may be used individually or as a combination thereof. The organosilicon compound may be used in combination with aluminum alkoxides and an internal electron donor.

The aluminum alkoxide referred to above may be of formula Al(OR′)₃ where each R′ is individually a hydrocarbon with up to 20 carbon atoms. This may include where each R′ is individually methyl, ethyl, n-propyl, iso-propyl, n-butyl, sec-butyl, tert-butyl, n-pentyl, iso-pentyl, neo-pentyl, etc.

Examples of the halide-containing magnesium compounds include magnesium chloride, magnesium bromide, magnesium iodide, and magnesium fluoride. In one embodiment, the halide-containing magnesium compound is magnesium chloride.

Illustrative of the epoxy compounds include, but are not limited to, glycidyl-containing compounds of the Formula:

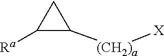

wherein “a” is from 1, 2, 3, 4, or 5, X is F, Cl, Br, I, or methyl, and R^{a} is H, alkyl, aryl, or cyclyl. In one embodiment, the alkylepoxide is epichlorohydrin. In some embodiments, the epoxy compound is a haloalkylepoxide or a nonhaloalkylepoxide.

According to some embodiments, the epoxy compound is selected from the group consisting of ethylene oxide; propylene oxide; 1,2-epoxybutane; 2,3-epoxybutane; 1,2-epoxyhexane; 1,2-epoxyoctane; 1,2-epoxydecane; 1,2-epoxydodecane; 1,2-epoxytetradecane; 1,2-epoxyhexadecane; 1,2-epoxyoctadecane; 7,8-epoxy-2-methyloctadecane; 2-vinyl oxirane; 2-methyl-2-vinyl oxirane; 1,2-epoxy-5-hexene; 1,2-epoxy-7-octene; 1-phenyl-2,3-epoxypropane; 1-(1-naphthyl)-2,3-epoxypropane; 1-cyclohexyl-3,4-epoxybutane; 1,3-butadiene dioxide; 1,2,7,8-diepoxyoctane; cyclopentene oxide; cyclooctene oxide; α-pinene oxide; 2,3-epoxynorbornane; limonene oxide; cyclodecane epoxide; 2,3,5,6-diepoxynorbornane; styrene oxide; 3-methylstyrene oxide; 1,2-epoxybutylbenzene; 1,2-epoxyoctylbenzene; stilbene oxide; 3-vinylstyrene oxide; 1-(1-methyl-1,2-epoxyethyl)-3-(1-methylvinyl benzene); 1,4-bis(1,2-epoxypropyl)benzene; 1,3-bis(1,2-epoxy-1-methylethyl)benzene; 1,4-bis(1,2-epoxy-1-methylethyl)benzene; epifluorohydrin; epichlorohydrin; epibromohydrin; hexafluoropropylene oxide; 1,2-epoxy-4-fluorobutane; 1-(2,3-epoxypropyl)-4-fluorobenzene; 1-(3,4-epoxybutyl)-2-fluorobenzene; 1-(2,3-epoxypropyl)-4-chlorobenzene; 1-(3,4-epoxybutyl)-3-chlorobenzene; 4-fluoro-1,2-cyclohexene oxide; 6-chloro-2,3-epoxybicyclo[2.2.1]heptane; 4-fluorostyrene oxide; 1-(1,2-epoxypropyl)-3-trifluorobenzene; 3-acetyl-1,2-epoxypropane; 4-benzoyl-1,2-epoxybutane; 4-(4-benzoyl)phenyl-1,2-epoxybutane; 4,4′-bis(3,4-epoxybutyl)benzophenone; 3,4-epoxy-1-cyclohexanone; 2,3-epoxy-5-oxobicyclo[2.2.1]heptane; 3-acetylstyrene oxide; 4-(1,2-epoxypropyl)benzophenone; glycidyl methyl ether; butyl glycidyl ether; 2-ethylhexyl glycidyl ether; allyl glycidyl ether; ethyl 3,4-epoxybutyl ether; glycidyl phenyl ether; glycidyl 4-tert-butylphenyl ether; glycidyl 4-chlorophenyl ether; glycidyl 4-methoxyphenyl ether; glycidyl 2-phenylphenyl ether; glycidyl 1-naphthyl ether; glycidyl 2-phenylphenyl ether; glycidyl 1-naphthyl ether; glycidyl 4-indolyl ether; glycidyl N-methyl-α-quinolon-4-yl ether; ethyleneglycol diglycidyl ether; 1,4-butanediol diglycidyl ether; 1,2-diglycidyloxybenzene; 2,2-bis(4-glycidyloxyphenyl) propane; tris(4-glycidyloxyphenyl) methane; poly(oxypropylene)triol triglycidyl ether; a glycidic ether of phenol novolac; 1,2-epoxy-4-methoxycyclohexane; 2,3-epoxy-5,6-dimethoxybicyclo[2.2.1]heptane; 4-methoxystyrene oxide; 1-(1,2-epoxybutyl)-2-phenoxybenzene; glycidyl formate; glycidyl acetate; 2,3-epoxybutyl acetate; glycidyl butyrate; glycidyl benzoate; diglycidyl terephthalate; poly(glycidyl acrylate); poly(glycidyl methacrylate); a copolymer of glycidyl acrylate with another monomer; a copolymer of glycidyl methacrylate with another monomer; 1,2-epoxy-4-methoxycarbonylcyclohexane; 2,3-epoxy-5-butoxycarbonylbicyclo[2.2.1]heptane; ethyl 4-(1,2-epoxyethyl)benzoate; methyl 3-(1,2-epoxybutyl)benzoate; methyl 3-(1,2-epoxybutyl)-5-pheylbenzoate; N,N-glycidyl-methylacetamide; N,N-ethylglycidylpropionamide; N,N-glycidylmethylbenzamide; N-(4,5-epoxypentyl)-N-methyl-benzamide; N,N-diglycylaniline; bis(4-diglycidylaminophenyl) methane; poly(N,N-glycidylmethylacrylamide); 1,2-epoxy-3-(diphenylcarbamoyl)cyclohexane; 2,3-epoxy-6-(dimethylcarbamoyl) bicycle[2.2.1]heptane; 2-(dimethylcarbamoyl) styrene oxide; 4-(1,2-epoxybutyl)-4′-(dimethylcarbamoyl) biphenyl; 4-cyano-1,2-epoxybutane; 1-(3-cyanophenyl)-2,3-epoxybutane; 2-cyanostyrene oxide; and 6-cyano-1-(1,2-epoxy-2-phenylethyl) naphthalene.

As an example of the organic phosphorus compound, phosphate acid esters such as trialkyl phosphate acid ester may be used. Such compounds may be represented by the formula:

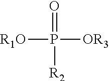

wherein R₁, R₂, and R₃ are each independently selected from the group consisting of methyl, ethyl, and linear or branched (C₃-C₁₀) alkyl groups. In one embodiment, the trialkyl phosphate acid ester is tributyl phosphate acid ester.

In still another embodiment, a substantially spherical MgCl₂-nEtOH adduct may be formed by a spray crystallization process. In the process, a MgCl₂-nROH melt, where n is 1-6, is sprayed inside a vessel while conducting inert gas at a temperature of 20-80° C. into the upper part of the vessel. The melt droplets are transferred to a crystallization area into which inert gas is introduced at a temperature of −50 to 20° C. crystallizing the melt droplets into non-agglomerated, solid particles of spherical shape. The spherical MgCl₂ particles are then classified into the desired size. Particles of undesired size can be recycled. In preferred embodiments for catalyst synthesis the spherical MgCl₂ precursor has an average particle size (Malvern d₅₀) of between about 8-150 microns, preferably between 10-100 microns, and most preferably between 10-30 microns.

The catalyst component may be converted to a solid catalyst by way of halogenation. Halogenation includes contacting the catalyst component with a halogenating agent in the presence of the internal electron donor. Halogenation converts the magnesium moiety present in the catalyst component into a magnesium halide support upon which the titanium moiety (such as a titanium halide) is deposited. Not wishing to be bound by any particular theory, it is believed that during halogenation the internal electron donor (1) regulates the position of titanium on the magnesium-based support, (2) facilitates conversion of the magnesium and titanium moieties into respective halides and (3) regulates the crystallite size of the magnesium halide support during conversion. Thus, provision of the internal electron donor yields a catalyst composition with enhanced stereoselectivity.

In an embodiment, the halogenating agent is a titanium halide having the formula Ti(OR^{e})_{f}Xₕ wherein R^{e} and X are defined as above, f is an integer from 0 to 3; h is an integer from 1 to 4; and f+h is 4. In an embodiment, the halogenating agent is TiCl₄. In a further embodiment, the halogenation is conducted in the presence of a chlorinated or a non-chlorinated aromatic liquid, such as dichlorobenzene, o-chlorotoluene, chlorobenzene, benzene, toluene, or xylene. In yet another embodiment, the halogenation is conducted by use of a mixture of halogenating agent and chlorinated aromatic liquid comprising from 40 to 60 volume percent halogenating agent, such as TiCl₄.

The reaction mixture can be heated during halogenation. The catalyst component and halogenating agent are contacted initially at a temperature of less than about 10° C., such as less than about 0° C., such as less than about −10° C., such as less than about −20° C., such as less than about −30° C. The initial temperature is generally greater than about −50° C., such as greater than about −40° C. The mixture is then heated at a rate of 0.1 to 10.0° C./minute, or at a rate of 1.0 to 5.0° C./minute. The internal electron donor may be added later, after an initial contact period between the halogenating agent and catalyst component. Temperatures for the halogenation are from 20° C. to 150° C. (or any value or subrange therebetween), or from 0° C. to 120° C. Halogenation may be continued in the substantial absence of the internal electron donor for a period from 5 to 60 minutes, or from 10 to 50 minutes.

The manner in which the catalyst component, the halogenating agent and the internal electron donor are contacted may be varied. In an embodiment, the catalyst component is first contacted with a mixture containing the halogenating agent and a chlorinated aromatic compound. The resulting mixture is stirred and may be heated if desired. Next, the internal electron donor is added to the same reaction mixture without isolating or recovering of the precursor. The foregoing process may be conducted in a single reactor with addition of the various ingredients controlled by automated process controls.

In one embodiment, the catalyst component is contacted with the internal electron donor before reacting with the halogenating agent.

Contact times of the catalyst component with the internal electron donor are at least 10 minutes, or at least 15 minutes, or at least 20 minutes, or at least 1 hour at a temperature from at least −30° C., or at least −20° C., or at least 10° C. up to a temperature of 150° C., or up to 120° C., or up to 115° C., or up to 110° C.

In one embodiment, the catalyst component, the internal electron donor, and the halogenating agent are added simultaneously or substantially simultaneously.

The halogenation procedure may be repeated one, two, three, or more times as desired. In an embodiment, the resulting solid material is recovered from the reaction mixture and contacted one or more times in the absence (or in the presence) of the same (or different) internal electron donor components with a mixture of the halogenating agent in the chlorinated aromatic compound for at least about 10 minutes, or at least about 15 minutes, or at least about 20 minutes, and up to about 10 hours, or up to about 45 minutes, or up to about 30 minutes, at a temperature from at least about −20° C., or at least about 0° C., or at least about 10° C., to a temperature up to about 150° C., or up to about 120° C., or up to about 115° C.

After the foregoing halogenation procedure, the resulting solid catalyst composition is separated from the reaction medium employed in the final process, by filtering for example, to produce a moist filter cake. The moist filter cake may then be rinsed or washed with a liquid diluent to remove unreacted TiCl₄ and may be dried to remove residual liquid, if desired. Typically the resultant solid catalyst composition is washed one or more times with a “wash liquid,” which is a liquid hydrocarbon such as an aliphatic hydrocarbon such as isopentane, isooctane, isohexane, hexane, pentane, or octane. The solid catalyst composition then can be separated and dried or slurried in a hydrocarbon, especially a relatively heavy hydrocarbon such as mineral oil for further storage or use.

In one embodiment, the resulting solid catalyst composition has a titanium content of from about 1.0 percent by weight to about 6.0 percent by weight, based on the total solids weight, or from about 1.5 percent by weight to about 4.5 percent by weight, or from about 2.0 percent by weight to about 3.5 percent by weight. The weight ratio of titanium to magnesium in the solid catalyst composition is suitably between about 1:3 and about 1:160, or between about 1:4 and about 1:50, or between about 1:6 and 1:30. In an embodiment, the internal electron donor may be present in the catalyst composition in a molar ratio of internal electron donor to magnesium of from about 0.005:1 to about 1:1, or from about 0.01:1 to about 0.4:1. Weight percent is based on the total weight of the catalyst composition.

The catalyst composition may be further treated by one or more of the following procedures prior to or after isolation of the solid catalyst composition. The solid catalyst composition may be contacted (halogenated) with a further quantity of titanium halide compound, if desired; it may be exchanged under metathesis conditions with an acid chloride, such as phthaloyl dichloride or benzoyl chloride; and it may be rinsed or washed, heat treated; or aged. The foregoing additional procedures may be combined in any order or employed separately, or not at all.

As described above, the catalyst composition can include a combination of a magnesium moiety, a titanium moiety and the internal electron donor. The catalyst composition is produced by way of the foregoing halogenation procedure which converts the catalyst component and the internal electron donor into the combination of the magnesium and titanium moieties, into which the internal electron donor is incorporated. The catalyst component from which the catalyst composition is formed can be any of the above described catalyst precursors, including the magnesium moiety precursor, the mixed magnesium/titanium precursor, the benzoate-containing magnesium chloride precursor, the magnesium, titanium, epoxy, and phosphorus precursor, or the spherical precursor.

Various different types of internal electron donors may be incorporated into the solid catalyst component. In one embodiment, the internal electron donor is an aryl diester, such as a phenylene-substituted diester. In one embodiment, the internal electron donor may have the following chemical structure:

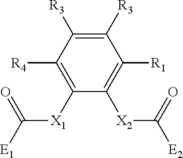

wherein R₁, R₂, R₃ and R₄ are each a hydrocarbyl group having from 1 to 20 carbon atoms, the hydrocarbyl group having a branched or linear structure or comprising a cycloalkyl group having from 7 to 15 carbon atoms, and where E₁ and E₂ are the same or different and selected from the group consisting of an alkyl having 1 to 20 carbon atoms, a substituted alkyl having 1 to 20 carbon atoms, an aryl having 1 to 20 carbon atoms, a substituted aryl having 1 to 20 carbon atoms, or an inert functional group having 1 to 20 carbon atoms and optionally containing heteroatoms, and wherein X₁ and X₂ are each O, S, an alkyl group, or NR₅ and wherein R₅ is a hydrocarbyl group having 1 to 20 carbon atoms or is hydrogen.

As used herein, the term “hydrocarbyl” and “hydrocarbon” refer to substituents containing only hydrogen and carbon atoms, including branched or unbranched, saturated or unsaturated, cyclic, polycyclic, fused, or acyclic species, and combinations thereof. Nonlimiting examples of hydrocarbyl groups include alkyl-, cycloalkyl-, alkenyl-, alkadienyl-, cycloalkenyl-, cycloalkadienyl-, aryl-, aralkyl, alkylaryl, and alkynyl-groups.

As used herein, the terms “substituted hydrocarbyl” and “substituted hydrocarbon” refer to a hydrocarbyl group that is substituted with one or more nonhydrocarbyl substituent groups. A nonlimiting example of a nonhydrocarbyl substituent group is a heteroatom. As used herein, a “heteroatom” refers to an atom other than carbon or hydrogen. The heteroatom can be a non-carbon atom from Groups IV, V, VI, and VII of the Periodic Table. Nonlimiting examples of heteroatoms include: halogens (F, Cl, Br, I), N, O, P, B, S, and Si. A substituted hydrocarbyl group also includes a halohydrocarbyl group and a silicon-containing hydrocarbyl group. As used herein, the term “halohydrocarbyl” group refers to a hydrocarbyl group that is substituted with one or more halogen atoms. As used herein, the term “silicon-containing hydrocarbyl group” is a hydrocarbyl group that is substituted with one or more silicon atoms. The silicon atom(s) may or may not be in the carbon chain.

In one aspect, the substituted phenylene diester has the following structure (I):

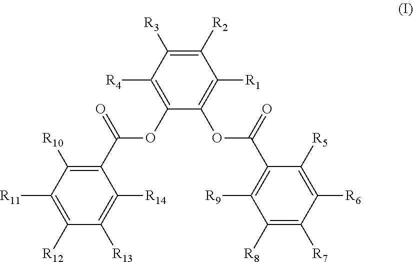

In an embodiment, structure (I) includes R₁ and R₃ that is an isopropyl group. Each of R₂, R₄, and R₅-R₁₄ is hydrogen.

In an embodiment, structure (I) includes each of R₁, R₅, and R₁₀ as a methyl group and R₃ is a t-butyl group. Each of R₂, R₄, R₆-R₉, and R₁₁-R₁₄ is hydrogen.

In an embodiment, structure (I) includes each of R₁, R₇, and R₁₂ as a methyl group and R₃ is a t-butyl group. Each of R₂, R₄, R₅, R₆, R₈, R₉, R₁₀, R₁₁, R₁₃, and R₁₄ is hydrogen.

In an embodiment, structure (I) includes R₁ as a methyl group and R₃ is a t-butyl group. Each of R₇ and R₁₂ is an ethyl group. Each of R₂, R₄, R₅, R₆, R₈, R₉, R₁₀, R₁₁, R₁₃, and R₁₄ is hydrogen.

In an embodiment, structure (I) includes each of R₁, R₅, R₇, R₉, R₁₀, R₁₂, and R₁₄ as a methyl group and R₃ is a t-butyl group. Each of R₂, R₄, R₆, R₈, R₁₁, and R₁₃ is hydrogen.

In an embodiment, structure (I) includes R₁ as a methyl group and R₃ is a t-butyl group. Each of R₅, R₇, R₉, R₁₀, R₁₂, and R₁₄ is an i-propyl group. Each of R₂, R₄, R₆, R₈, R₁₁, and R₁₃ is hydrogen.

In an embodiment, the substituted phenylene aromatic diester has a structure selected from the group consisting of structures (II)-(V), including alternatives for each of R₁ to R₁₄, that are described in detail in U.S. Pat. No. 8,536,372, which is incorporated herein by reference.

In an embodiment, structure (I) includes R₁ that is a methyl group and R₃ is a t-butyl group. Each of R₇ and R₁₂ is an ethoxy group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is a fluorine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is a chlorine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is a bromine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is an iodine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₆, R₇, R₁₁, and R₁₂ is a chlorine atom. Each of R₂, R₄, R₅, R₈, R₉, R₁₀, R₁₃, and R₁₄ is hydrogen.

In an embodiment, structure (I) includes R₁ that is a methyl group and R₃ is a t-butyl group. Each of R₆, R₈, R₁₁, and R₁₃ is a chlorine atom. Each of R₂, R₄, R₅, R₇, R₉, R₁₀, R₁₂, and R₁₄ is hydrogen.

In an embodiment, structure (I) includes R₁ that is a methyl group and R₃ is a t-butyl group. Each of R₂, R₄, and R₅-R₁₄ is a fluorine atom.

In an embodiment, structure (I) includes R₁ that is a methyl group and R₃ is a t-butyl group. Each of Rand R₁₂ is a trifluoromethyl group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is an ethoxycarbonyl group. Each of R₂, R₄, R₅, R₆, R₈, R₉, R₁₀, R₁₁, R₁₃, and R₁₄ is hydrogen.

In an embodiment, Riis methyl group and R₃ is a t-butyl group. Each of R₇ and R₁₂ is an ethoxy group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is a diethylamino group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a 2,4,4-trimethylpentan-2-yl group. Each of R₂, R₄, and R₅-R₁₄ is hydrogen.

In an embodiment, structure (I) includes R₁ and R₃, each of which is a sec-butyl group. Each of R₂, R₄, and R₅-R₁₄ is hydrogen.

In an embodiment, structure (I) includes R₁ and R₄ that are each a methyl group. Each of R₂, R₃, R₅-R₉, and R₁₀-R₁₄ is hydrogen.

In an embodiment, structure (I) includes R₁ that is a methyl group. R₄ is an i-propyl group. Each of R₂, R₃, R₅-R₉, and R₁₀-R₁₄ is hydrogen.

In an embodiment, structure (I) includes R₁, R₃, and R₄, each of which is an i-propyl group. Each of R₂, R₅-R₉, and R₁₀-R₁₄ is hydrogen.

In another aspect, the internal electron donor can be a phthalate compound. For example, the phthalate compound can be dimethyl phthalate, diethyl phthalate, dipropyl phthalate, diisopropyl phthalate, dibutyl phthalate, diisobutyl phthalate, diamyl phthalate, diisoamyl phthalate, methylbutyl phthalate, ethylbutyl phthalate, or ethylpropyl phthalate.

In addition to the solid catalyst component as described above, the Ziegler-Natta catalyst system of the present disclosure can also include a cocatalyst. The cocatalyst may include hydrides, alkyls, or aryls of aluminum, lithium, zinc, tin, cadmium, beryllium, magnesium, and combinations thereof. In an embodiment, the cocatalyst is a hydrocarbyl aluminum cocatalyst represented by the formula R₃Al wherein each R is an alkyl, cycloalkyl, aryl, or hydride radical; at least one R is a hydrocarbyl radical; two or three R radicals can be joined in a cyclic radical forming a heterocyclic structure; each R can be the same or different; and each R, which is a hydrocarbyl radical, has 1 to 20 carbon atoms, and preferably 1 to 10 carbon atoms. In a further embodiment, each alkyl radical can be straight or branched chain and such hydrocarbyl radical can be a mixed radical, i.e., the radical can contain alkyl, aryl, and/or cycloalkyl groups. Nonlimiting examples of suitable radicals are: methyl, ethyl, n-propyl, isopropyl, n-butyl, isobutyl, tert-butyl, n-pentyl, neopentyl, n-hexyl, 2-methylpentyl, n-heptyl, n-octyl, isooctyl, 2-ethylhexyl, 5,5-dimethylhexyl, n-nonyl, n-decyl, isodecyl, n-undecyl, or n-dodecyl.

Nonlimiting examples of suitable hydrocarbyl aluminum compounds are as follows: triisobutylaluminum, tri-n-hexylaluminum, diisobutylaluminum hydride, di-n-hexylaluminum hydride, isobutylaluminum dihydride, n-hexylaluminum dihydride, diisobutylhexylaluminum, isobutyldihexylaluminum, trimethylaluminum, triethylaluminum, tri-n-propylaluminum, triisopropylaluminum, tri-n-butylaluminum, tri-n-octylaluminum, tri-n-decylaluminum, or tri-n-dodecylaluminum. In an embodiment, the cocatalyst is triethylaluminum, triisobutylaluminum, tri-n-hexylaluminum, diisobutylaluminum hydride, or di-n-hexylaluminum hydride.

In an embodiment, the cocatalyst is triethylaluminum. The molar ratio of aluminum to titanium is from about 5:1 to about 500:1, or from about 10:1 to about 200:1, or from about 15:1 to about 150:1, or from about 20:1 to about 100:1. In another embodiment, the molar ratio of aluminum to titanium is about 45:1.

Suitable catalyst compositions can include the solid catalyst component, a co-catalyst, and an external electron donor that can be a mixed external electron donor (M-EED) of two or more different components. Suitable external electron donors or “external donor” include one or more selectivity control agents (SCA) and/or one or more activity limiting agents (ALA). As used herein, an “external donor” is a component or a composition comprising a mixture of components added independent of procatalyst formation that modifies the catalyst performance. As used herein, an “activity limiting agent” is a composition that decreases catalyst activity as the polymerization temperature in the presence of the catalyst rises above a threshold temperature (e.g., temperature greater than about 95° C.). A “selectivity control agent” is a composition that improves polymer tacticity, wherein improved tacticity is generally understood to mean increased tacticity or reduced xylene solubles or both. It should be understood that the above definitions are not mutually exclusive and that a single compound may be classified, for example, as both an activity limiting agent and a selectivity control agent.

A selectivity control agent in accordance with the present disclosure is generally an organosilicon compound. For example, in one aspect, the selectively control agent can be an alkoxysilane.

In one embodiment, the alkoxysilane can have the following general formula: SiRₘ(OR′)₄₋ₘ (I) where R independently each occurrence is hydrogen or a hydrocarbyl or an amino group optionally substituted with one or more substituents containing one or more Group 14, 15, 16, or 17 heteroatoms, said R containing up to 20 atoms not counting hydrogen and halogen; R′ is a C₁₋₄ alkyl group; and m is 0, 1, 2 or 3. In an embodiment, R is C₆₋₁₂ aryl, alkyl or aralkyl, C₃₋₁₂ cycloalkyl, C₃₋₁₂ branched alkyl, or C₃₋₁₂ cyclic or acyclic amino group, R′ is C₁₋₄ alkyl, and m is 1 or 2. In one embodiment, for instance, the second selectivity control agent may include n-propyltriethoxysilane. Other selectively control agents that can be used include propyltriethoxysilane and/or diisobutyldimethoxysilane.

In one embodiment, the catalyst system may include an activity limiting agent (ALA). An ALA inhibits or otherwise prevents polymerization reactor upset and ensures continuity of the polymerization process. Typically, the activity of Ziegler-Natta catalysts increases as the reactor temperature rises before reaching a very high level. Ziegler-Natta catalysts also typically maintain high activity near the melting point temperature of the polymer produced. The heat generated by the exothermic polymerization reaction may cause polymer particles to form agglomerates and may ultimately lead to disruption of continuity for the polymer production process. The ALA reduces catalyst activity at elevated temperature, thereby preventing reactor upset, reducing (or preventing) particle agglomeration, and ensuring continuity of the polymerization process.

The activity limiting agent may be a carboxylic acid ester. The aliphatic carboxylic acid ester may be a C₄-C₃₀ aliphatic acid ester, may be a mono- or a poly-(two or more) ester, may be straight chain or branched, may be saturated or unsaturated, and any combination thereof. The C₄-C₃₀ aliphatic acid ester may also be substituted with one or more Group 14, 15 or 16 heteroatom containing substituents. Nonlimiting examples of suitable C₄-C₃₀ aliphatic acid esters include C₁₋₂₀ alkyl esters of aliphatic C₄₋₃₀ monocarboxylic acids, C₁₋₂₀ alkyl esters of aliphatic C₈₋₂₀ monocarboxylic acids, C₁₋₄ allyl mono- and diesters of aliphatic C₄₋₂₀ monocarboxylic acids and dicarboxylic acids, C₁₋₄ alkyl esters of aliphatic C₈₋₂₀ monocarboxylic acids and dicarboxylic acids, and C₄₋₂₀ mono- or polycarboxylate derivatives of C₂₋₁₀₀ (poly)glycols or C₂₋₁₀₀ (poly)glycol ethers. In a further embodiment, the C₄-C₃₀ aliphatic acid ester may be a laurate, a myristate, a palmitate, a stearate, an oleates, a sebacate, (poly) (alkylene glycol) mono- or diacetates, (poly) (alkylene glycol) mono- or di-myristates, (poly) (alkylene glycol) mono- or di-laurates, (poly) (alkylene glycol) mono- or di-oleates, glyceryl tri (acetate), glyceryl tri-ester of C₂₋₄₀ aliphatic carboxylic acids, and mixtures thereof. In a further embodiment, the C₄-C₃₀ aliphatic ester is isopropyl myristate, di-n-butyl sebacate and/or pentyl valerate.

In one embodiment, the selectivity control agent and/or activity limiting agent can be added into the reactor separately. In another embodiment, the selectivity control agent and the activity limiting agent can be mixed together in advance and then added into the reactor as a mixture. In addition, the selectivity control agent and/or activity limiting agent can be added into the reactor in different ways. For example, in one embodiment, the selectivity control agent and/or the activity limiting agent can be added directly into the reactor, such as into a fluidized bed reactor. Alternatively, the selectivity control agent and/or activity limiting agent can be added indirectly to the reactor volume by being fed through, for instance, a cycle loop (for example, the Line 22 in FIG. 1). The selectivity control agent and/or activity limiting agent can combine with the reactor cycle gas within the cycle loop prior to being fed into the reactor.

In addition to Ziegler-Natta catalysts, the process and system of the present disclosure may also use a metallocene catalyst. Metallocene catalysts can include “half sandwich” and “full sandwich” compounds having one or more Cp ligands (cyclopentadienyl and ligands isolobal to cyclopentadienyl) bound to at least one Group 3 to Group 12 metal atom, and one or more leaving group(s) bound to the at least one metal atom.

The Cp ligands are one or more rings or ring system(s), at least a portion of which includes-bonded systems, such as cycloalkadienyl ligands and heterocyclic analogues. The ring(s) or ring system(s) typically comprise atoms selected from Groups 13 to 16 atoms, and, in some embodiments, the atoms that make up the Cp ligands are selected from carbon, nitrogen, oxygen, silicon, sulfur, phosphorous, germanium, boron, aluminum, and combinations thereof, where carbon makes up at least 50% of the ring members. For example, the Cp ligand(s) may be selected from substituted and unsubstituted cyclopentadienyl ligands and ligands isolobal to cyclopentadienyl. Non-limiting examples of such ligands include cyclopentadienyl, cyclopentaphenanthrenyl, indenyl, benzindenyl, fluorenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7-H-dibenzofluorenyl, indeno[1,2-9]anthrene, thiophenoindenyl, thiophenofluorenyl, hydrogenated versions thereof (e.g., 4,5,6,7-tetrahydroindenyl, or “H₄ Ind”), substituted versions thereof (as discussed and described in more detail below), and heterocyclic versions thereof.

The metal atom “M” of the metallocene compound may be selected from Groups 3 through 12 atoms and lanthanide Group atoms; or may be selected from Groups 3 through 10 atoms; or may be selected from Sc, Ti, Zr, Hf, V, Nb, Ta, Mn, Re, Fe, Ru, Os, Co, Rh, Ir, and Ni; or may be selected from Groups 4, 5, and 6 atoms; or may be Ti, Zr, or Hf atoms; or may be Hf; or may be Zr. The oxidation state of the metal atom “M” can range from 0 to +7; or may be +1, +2, +3, +4, or +5; or may be +2, +3 or +4. The groups bound to the metal atom “M” are such that the compounds described below in the structures and structures are electrically neutral, unless otherwise indicated. The Cp ligand(s) forms at least one chemical bond with the metal atom M to form the “metallocene catalyst component.” The Cp ligands are distinct from the leaving groups bound to metal atom M in that they are not highly susceptible to substitution/abstraction reactions.

In one embodiment, the metallocene catalyst may be represented by the following formula:

(C₅Rₓ)_{y}R′_{z}(C₅Rₘ)MQ_{n-y-1}.

In the formula above, M is a metal of Groups IIIB to VIII of the Periodic Table of the Elements; (C₅Rₓ) and (C₅Rₘ) are the same or different cyclopentadienyl or substituted cyclopentadienyl groups bonded to M; R is the same or different and is hydrogen or a hydrocarbyl radical such as alkyl, alkenyl, aryl, alkylaryl, or arylalkyl radical containing from 1 to 20 carbon atoms or two carbon atoms are joined together to form a C₄-C₆ ring; R′ is a C₁-C₄ substituted or unsubstituted alkylene radical, a dialkyl or diaryl germanium or silicon, or an alkyl or aryl phosphine or amine radical bridging two (C₅Rₓ) and (C₅Rₘ) rings; Q is a hydrocarbyl radical such as aryl, alkyl, alkenyl, alkylaryl, or aryl alkyl radical having from 1-20 carbon atoms, hydrocarboxy radical having from 1-20 carbon atoms or halogen and can be the same or different from each other; z is 0 or 1; y is 0, 1 or 2; z is 0 when y is 0; n is 0, 1, 2, 3, or 4 depending upon the valence state of M; and n−y is >1.

Illustrative but non-limiting examples of the metallocenes represented by the above formula are dialkyl metallocenes such as bis(cyclopentadienyl)titanium dimethyl, bis(cyclopentadienyl)titanium diphenyl, bis(cyclopentadienyl) zirconium dimethyl, bis(cyclopentadienyl) zirconium diphenyl, bis(cyclopentadienyl)hafnium dimethyl and diphenyl, bis(cyclopentadienyl)titanium di-neopentyl, bis(cyclopentadienyl) zirconium di-neopentyl, bis(cyclopentadienyl)titanium dibenzyl, bis(cyclopentadienyl) zirconium dibenzyl, bis(cyclopentadienyl) vanadium dimethyl; the mono alkyl metallocenes such as bis(cyclopentadienyl)titanium methyl chloride, bis(cyclopentadienyl)titanium ethyl chloride, bis(cyclopentadienyl)titanium phenyl chloride, bis(cyclopentadienyl) zirconium methyl chloride, bis(cyclopentadienyl) zirconium ethyl chloride, bis(cyclopentadienyl) zirconium phenyl chloride, bis(cyclopentadienyl)titanium methyl bromide; the trialkyl metallocenes such as cyclopentadienyl titanium trimethyl, cyclopentadienyl zirconium triphenyl, and cyclopentadienyl zirconium trineopentyl, cyclopentadienyl zirconium trimethyl, cyclopentadienyl hafnium triphenyl, cyclopentadienyl hafnium trineopentyl, and cyclopentadienyl hafnium trimethyl; monocyclopentadienyls titanocenes such as, pentamethylcyclopentadienyl titanium trichloride, pentaethylcyclopentadienyl titanium trichloride; bis(pentamethylcyclopentadienyl)titanium diphenyl, the carbene represented by the formula bis(cyclopentadienyl)titanium=CH₂ and derivatives of this reagent; substituted bis(cyclopentadienyl)titanium (IV) compounds such as: bis(indenyl)titanium diphenyl or dichloride, bis(methylcyclopentadienyl)titanium diphenyl or dihalides; dialkyl, trialkyl, tetra-alkyl and penta-alkyl cyclopentadienyl titanium compounds such as bis(1,2-dimethylcyclopentadienyl)titanium diphenyl or dichloride, bis(1,2-diethylcyclopentadienyl)titanium diphenyl or dichloride; silicon, phosphine, amine or carbon bridged cyclopentadiene complexes, such as dimethyl silyldicyclopentadienyl titanium diphenyl or dichloride, methyl phosphine dicyclopentadienyl titanium diphenyl or dichloride, methylenedicyclopentadienyl titanium diphenyl or dichloride and other dihalide complexes, and the like; as well as bridged metallocene compounds such as isopropyl(cyclopentadienyl)(fluorenyl) zirconium dichloride, isopropyl(cyclopentadienyl) (octahydrofluorenyl) zirconium dichloride diphenylmethylene(cyclopentadienyl)(fluorenyl) zirconium dichloride, diisopropylmethylene(cyclopentadienyl)(fluorenyl) zirconium dichloride, diisobutylmethylene(cyclopentadienyl)(fluorenyl) zirconium dichloride, ditertbutylmethylene (cyclopentadienyl)(fluorenyl) zirconium dichloride, cyclohexylidene (cyclopentadienyl)(fluorenyl) zirconium dichloride, diisopropylmethylene (2,5-dimethylcyclopentadienyl)(fluorenyl) zirconium dichloride, isopropyl(cyclopentadienyl)(fluorenyl)hafnium dichloride, diphenylmethylene (cyclopentadienyl)(fluorenyl)hafnium dichloride, diisopropylmethylene(cyclopentadienyl) (fluorenyl)hafnium dichloride, diisobutylmethylene(cyclopentadienyl)(fluorenyl) hafnium dichloride, ditertbutylmethylene (cyclopentadienyl)(fluorenyl)hafnium dichloride, cyclohexylidene (cyclopentadienyl)(fluorenyl)hafnium dichloride, diisopropylmethylene(2,5-dimethylcyclopentadienyl)(fluorenyl)hafnium dichloride, isopropyl(cyclopentadienyl)(fluorenyl)titanium dichloride, diphenylmethylene(cyclopentadienyl)(fluorenyl)titanium dichloride, diisopropylmethylene(cyclopentadienyl)(fluorenyl)titanium dichloride, diisobutylmethylene(cyclopentadienyl)(fluorenyl)titanium dichloride, ditertbutylmethylene (cyclopentadienyl)(fluorenyl)titanium dichloride, cyclohexylidene (cyclopentadienyl)(fluorenyl)titanium dichloride, diisopropylmethylene(2,5 dimethylcyclopentadienyl fluorenyl)titanium dichloride, racemic-ethylene bis(1-indenyl) zirconium (IV) dichloride, racemic-ethylene bis(4,5,6,7-tetrahydro-1-indenyl) zirconium (IV) dichloride, racemic-dimethylsilyl bis(1-indenyl) zirconium (IV) dichloride, racemic-dimethylsilyl bis(4,5,6,7-tetrahydro-1-indenyl) zirconium (IV) dichloride, racemic-1,1,2,2-tetramethylsilanylene bis(1-indenyl) zirconium (IV) dichloride, racemic-1,1,2,2-tetramethylsilanylene bis(4,5,6,7-tetrahydro-1-indenyl) zirconium (IV), dichloride, ethylidene (1-indenyl tetramethylcyclopentadienyl) zirconium (IV) dichloride, racemic-dimethylsilyl bis(2-methyl-4-t-butyl-1-cyclopentadienyl) zirconium (IV) dichloride, racemic-ethylene bis(1-inden Yl) hafnium (IV) dichloride, racemic-ethylene bis(4,5,6,7-tetrahydro-1-indenyl)hafnium (IV) dichloride, racemic-dimethylsilyl bis(1-indenyl)hafnium (IV) dichloride, racemic-dimethylsilyl bis(4,5,6,7-tetrahydro-1-indenyl)hafnium (IV) dichloride, racemic-1,1,2,2-tetramethylsilanylene bis(1-indenyl)hafnium (IV) dichloride, racemic-1,1,2,2-tetramethylsilanylene bis(4,5,6,7-tetrahydro-1-indenyl)hafnium (IV), dichloride, ethylidene (1-indenyl-2,3,4,5-tetramethyl-1-cyclopentadienyl)hafnium (IV) dichloride, racemic-ethylene bis(1-indenyl)titanium (IV) dichloride, racemic-ethylene bis(4,5,6,7-tetrahydro-1-indenyl)titanium (IV) dichloride, racemic-dimethylsilyl bis(1-indenyl) titanium (IV) dichloride, racemic-dimethylsilyl bis(4,5,6,7-tetrahydro-1-indenyl)titanium (IV) dichloride, racemic-1,1,2,2-tetramethylsilanylene bis(1-indenyl)titanium (IV) dichloride racemic-1,1,2,2-tetramethylsilanylene bis(4,5,6,7-tetrahydro-1-indenyl) titanium (IV) dichloride, or ethylidene (1-indenyl-2,3,4,5-tetramethyl-1-cyclopentadienyl) titanium IV) dichloride.

A co-catalyst may also be used with the metallocene catalyst. The co-catalyst, for instance, may be an aluminoxane. Co-catalysts that may be used include those that have the following general formula:

M³M⁴ᵥX²_{c}R³_{b-c}

In the above formula, M³ is a metal of Groups IA, IIA and IIIA of the periodic table; M⁴ is a metal of Group IA of the Periodic table; v is a number from 0 to 1; each X² is any halogen; c is a number from 0 to 3; each R³ is a monovalent hydrocarbon radical or hydrogen; b is a number from 1 to 4; and wherein b-c is at least 1.

Compounds having only one Group IA, IIA or IIIA metal which are suitable for the practice of the invention include compounds having the formula:

M³R³ₖ

In the above formula, M³ is a Group IA, IIA or IIIA metal, such as lithium, sodium, beryllium, barium, boron, aluminum, zinc, cadmium, and gallium; k equals 1, 2 or 3 depending upon the valency of M³ which valency in turn normally depends upon the particular group (i.e., IA, IIA or IIIA) to which M³ belongs; and each R³ may be any monovalent hydrocarbon radical. Examples of suitable R³ groups include any of the R³ groups aforementioned in connection with formula (V).

The present invention, thus generally described, will be understood more readily by reference to the following examples, which are provided by way of illustration and are not intended to be limiting of the present invention.

### EXAMPLES

The following examples were completed in order to demonstrate some of the advantages and benefits of the present disclosure.

A gas phase polymerization reactor, similar to the one illustrated in FIGS. 1 and 2, was operated with different catalyst particles in the catalyst stream. In these examples, Ziegler-Natta catalysts were used.

The gas phase polymerization reactor was operated in order to produce a polypropylene homopolymer having a targeted melt flow rate of about 3-45 g/10 min and a xylene soluble content of about 2.5%.

Example 1. A Ziegler-Natta catalyst shown in U.S. Pat. No. 9,593,182, Examples 9-10, and the external donor shown in U.S. Patent Application Publication No. 2011/0152067A1, Example B1 were employed to make polypropylene homopolymer, with melt flow rate of 45 g/10 min. and xylene soluble of 2.5%, in a commercial-scale gas-phase fluidized-bed polymerization reactor with the production rate of 37,500 kg per hour, at the reactor temperature of 70° C. and reactor total pressure of 3.1 MPa. The melt flow rate was measured in accordance with ASTM D1238-01, under the conditions of 2.16 kg weight and 230° C. The xylene soluble was measured in accordance with ASTM D5492. Vaporized propylene gas at 125° C. was used as the support gas for the catalyst injection. The catalyst injection system comprises a center catalyst injection tube with 0.375″ (9.53 mm) O.D. and 0.305″ (7.7 mm) ID, and a co-axial support tube with 15/32″ (11.9 mm) I.D. That made the cross-sectional area ratio of the support-gas path to the catalyst inlet tube about 0.85 (based on the ID of the tube). Two different trial runs were performed with this catalyst. During each trial run, all conditions remained the same except for the support gas stream velocity. The conditions were maintained stable for more than 16 hours to insure very stable operation. When the velocity was adjusted to 61 m/s, the average settled bulk density obtained was 413 kg/m³. The velocity was then reduced to 16 m/s and a settled bulk density was reduced to 372 kg/m³.

Example 2. A Ziegler-Natta catalyst shown in U.S. Pat. No. 5,093,415, Examples 4-6, and the external donor shown in U.S. Patent Application Publication No. 2011/0152067A1, Example I1 were employed to make polypropylene homopolymer, with melt flow rate of 3.3 g/10 min. and xylene soluble of 2.5%, in a commercial-scale gas-phase fluidized-bed polymerization reactor with the production rate of 37,500 kg per hour, at the reactor temperature of 70° C. and reactor total pressure of 3.1 MPa. Vaporized propylene gas at 125° C. was used as the support gas for the catalyst injection. The catalyst injection system is the same as that in Example 1. Two different trial runs were performed with this catalyst. During each trial run, all conditions remained the same except for the support gas stream velocity. The conditions were maintained stable for more than 24 hours to insure very stable operation. When the velocity was adjusted to 57 m/s, the average settled bulk density obtained was 260 kg/m³. The velocity was then reduced to 38 m/s and the average settled bulk density was increased to 297 kg/m³.

As shown above, for one Ziegle-Natta catalyst, increasing the velocity of the support gas stream dramatically improved settled bulk density. For a different Ziegle-Natta catalyst, however, reducing the velocity of the support gas stream resulted in a higher settled bulk density.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. A process for increasing a settled bulk density of a granular polyolefin polymer, the process comprising:
feeding a catalyst stream into a gas phase polymerization reactor, the catalyst stream comprising catalyst particles, optionally in slurry form by suspending in a mineral oil and/or other hydrocarbon liquid, contained in a carrier fluid;
feeding a support gas into the gas phase polymerization reactor together with the catalyst stream entering the reactor, the support gas being fed into the gas phase reactor at a velocity;
forming polyolefin particles in the gas phase polymerization reactor through contact with the catalyst particles and a monomer and optionally one or more comonomers; and
determining a settled bulk density of the granular polyolefin particles, and, based on the settled bulk density, selectively increasing or decreasing the velocity of the support gas in order to maintain the settled bulk density above a preset limit.

2. The process of claim 1, wherein the catalyst stream enters the gas phase polymerization reactor through a catalyst inlet having a cross-sectional area and wherein the support gas flows into the gas phase polymerization reactor through a gas supply inlet that has a cross-sectional area within 0.25 to 4.0 times that of the catalyst inlet.

3. The process of claim 1, wherein the support gas flows into the gas phase polymerization reactor in a manner that is concentric with the catalyst stream.

4. The process of claim 1, wherein the support gas comprises a monomer gas, an inert gas, or mixtures thereof.

5. The process of claim 1, wherein the support gas comprises propylene.

6. The process of claim 1, wherein the support gas consists of an inert gas.

7. The process of claim 1, wherein the carrier fluid comprises liquid propylene.

8. The process of claim 1, wherein the carrier fluid comprises an inert gas.

9. The process of claim 1, wherein the velocity of the support gas is configured to be adjusted from about 5.4 m/s to about 81 m/s.

10. The process of claim 1, wherein the catalyst particles comprise a Ziegler-Natta catalyst.

11. The process of claim 1, wherein the settled bulk density preset limit is greater than about 250 kg/m³.

12. The process of claim 1, wherein the settled bulk density preset limit is greater than about 350 kg/m³.

13. The process of claim 1, wherein the settled bulk density preset limit is greater than about 400 kg/m³.

14. The process of claim 1, wherein the support gas enters the gas phase polymerization reactor at a temperature of from about 100° C. to about 150° C.

15. The process of claim 10, wherein the Ziegler-Natta catalyst comprises a solid catalyst component, which comprises a magnesium moiety, a titanium moiety, an internal electron donor, at least one co-catalyst, at least one external electron donor comprising at least one selectivity control agent, and optionally at least one activity limiting agent.

16. (canceled)

17. The process of claim 15, wherein the internal electron donor comprises a substituted phenylene diester, and the solid catalyst component further comprises an organosilicon compound and an epoxy compound.

18. (canceled)

19. The process of claim 1, wherein the catalyst particles comprise a metallocene catalyst.

20-21. (canceled)

22. The process of claim 1, wherein the catalyst particles are in a slurry status before combined with the carrier fluid, the slurry comprising the catalyst particles and an oil, such as a mineral oil.

23. The process of claim 1, wherein the determined settled bulk density is communicated to a controller and wherein the controller, based upon the determined settled bulk density, is configured to increase or decrease the velocity of the support gas in order to increase the settled bulk density.

24. (canceled)

25. The process of claim 22, wherein the controller operates in an open feed loop, or a closed feed loop.

26. (canceled)
